(19) United States
(12) Patent Application Publication
(10) Pub. No.: US 2026/0120457 A1
(43) Pub. Date: Apr. 30, 2026

(54) SYSTEMS AND METHODS FOR DETECTING AND MONITORING UNMANNED AERIAL SYSTEMS

(71) Applicant: The MITRE Corporation, McLean, VA (US)

(72) Inventors: Greg TAVAREZ, Sumter, SC (US); Hiroshi N FUJII, Lowell, MA (US); Hannah M MORILAK, Fuquay-Varina, NC (US); Jeff WANG, Anderson, SC (US); Bry M LAWLOR, Leesburg, VA (US)

(73) Assignee: The MITRE Corporation, McLean, VA (US)

(21) Appl. No.: 18/913,598

(22) Filed: Oct. 11, 2024

Related U.S. Application Data
(60) Provisional application No. 63/544,029, filed on Oct. 13, 2023.

(51) Int. Cl. G06V 20/17; G06F 3/04817; G06N 20/00; G06T 7/20; G06T 7/70; G06V 10/74; G06V 20/52

(52) U.S. Cl. CPC G06V 20/17; G06F 3/04817; G06N 20/00; G06T 7/20; G06T 7/70; G06V 10/761; G06V 20/52; G06T 2207/20081

(57) ABSTRACT

Systems and methods are provided for detection and reporting of unmanned aerial systems based on image data using machine learning models. An exemplary system receives image data and position data from at least one imaging device, detects an unmanned aerial system based on the image data using a trained machine learning model, determines a position of the unmanned aerial system based on at least one of the image data and the position data, and generates an alert indicating detection of one or more unmanned aerial systems in the image data.

### CROSS REFERENCE TO RELATED APPLICATIONS

This application claims priority to U.S. Provisional Patent Application Ser. No. 63/544,029, filed Oct. 13, 2023, the entire contents of which are incorporated herein by reference.

### STATEMENT OF FEDERALLY SPONSORED RESEARCH OR DEVELOPMENT

This invention was made with government support under FA8702-21-C-0001 awarded by Air Force Central Command. The government has certain rights in the invention.

### FIELD

The present disclosure relates generally to unmanned aerial systems and more specifically to tracking unmanned aerial systems.

### BACKGROUND

Unmanned aerial systems are a persistent threat to military facilities, people, and assets stationed in and around hostile territories. As unmanned aerial system technologies become more pervasive, effective monitoring and reporting mechanisms will be critical for mitigating surveillance and attack threats in military settings, as well as to critical infrastructure facilities, large public gatherings such as sporting events, and so on. Existing systems for detecting and reporting sightings of unmanned aerial systems are often disorganized, leading to time-gaps between reporting and response mitigation efforts in response to a detected unmanned aerial system. Such gaps in reporting and corresponding response efforts threaten the safety of key facilities and personnel.

### SUMMARY

Described herein are systems, methods, devices, and non-transitory computer readable storage media for automatically detecting, reporting, and tracking unmanned aerial systems based on image data. An exemplary system receives image data and processes the image data to detect unmanned aerial systems. Upon detection of an unmanned aerial system, the system may generate alerts warning personnel that there is an unmanned aerial system in their vicinity. The system may also track the unmanned aerial systems across image data received at different times and from different imaging devices. Accordingly, the system provides a detection and early warning system that can track unmanned aerial systems using image data.

According to some embodiments, the systems and methods described herein provide a pipeline for ingesting and processing data transmitted from mobile devices (e.g., mobile phones, tablets, etc. carried by users of the system) and/or strategically positioned surveillance cameras. The data may include image data and position data. According to some embodiments, a user can capture one or more images of a suspected unmanned aerial system using a mobile imaging device and transmit the image and position data associated with a position of the user device to a processing engine. Additionally, or alternatively, image data (e.g., single snapshot images or video) from one or more surveillance cameras, along with position data associated with the surveillance cameras, can be transmitted to the processing engine.

The mobile imaging devices and/or surveillance cameras may be integrated into a processing engine to form a distributed and mobile monitoring network that enables efficient detection of unmanned aerial systems in and around the vicinity of military bases, critical infrastructure facilities, etc. According to certain embodiments, images from mobile imaging devices and/or surveillance cameras can be received by the processing engine and processed to detect unmanned aerial systems in the images. The processing engine may automatically analyze image data using one or more machine learning models, conventional algorithmic models, and/or hybrid models configured to detect, locate, and/or track unmanned aerial systems. In some embodiments, the processing engine tracks detected unmanned aerial systems based on image data submitted by respective imaging devices over a period of time and/or across image data transmitted to the processing engine by different imaging devices.

Upon detection of an unmanned aerial system, alerts and/or reports can be provided to users, such as users in the vicinity of the unmanned aerial system, which can allow for prompt mitigation efforts. Users may be informed that an unmanned aerial system has been detected, the location at which it was detected and, optionally, the type of unmanned aerial system, among other information. Thus, the systems and methods described herein are capable of real-time detection of unmanned aerial systems and automated distribution of alerts, such as to users nearby a detected unmanned aerial system.

An exemplary method comprises: receiving image data and position data from at least one imaging device; detecting an unmanned aerial system based on the image data using a trained machine learning model; determining a position of the unmanned aerial system based on at least one of the image data and the position data; and generating an alert indicating detection of the unmanned aerial system.

In some embodiments, the position data comprises data corresponding to at least one of a geographic location of the at least one imaging device, a bearing of the at least one imaging device, and an observation angle of the at least one imaging device.

In some embodiments, the method further comprises: determining a distance between the at least one imaging device and the one or more unmanned aerial systems based on the image data and the position data.

In some embodiments, the method further comprises: determining an altitude of the one or more unmanned aerial systems based on the observation angle of the imaging device and the distance between the imaging device and the one or more unmanned aerial systems.

In some embodiments, the method further comprises: determining a type of the unmanned aerial system based on the image data.

In some embodiments, the method further comprises: determining at least one of a tactical use, a flight time capacity, a payload capacity, and a control frequency based on the type of unmanned aerial system.

In some embodiments, the method further comprises: tracking an unmanned aerial system based on the image data and the position data from a first imaging device and the image data and the position data from a second imaging device.

In some embodiments, determining a position of the unmanned aerial system based on at least one of the image data and the position data comprises: determining a position of the unmanned aerial system based on at least one of the image data and the position data received at a first time; and updating the position of the unmanned aerial system based on at least one of the image data and the position data received at a second time.

In some embodiments, determining a position of the unmanned aerial system based on at least one of the image data and the position data comprises: detecting a first unmanned aerial system based on a first image; detecting a second unmanned aerial system based on a second image; and determining that the first unmanned aerial system is the same unmanned aerial system as the second unmanned aerial system.

In some embodiments, the method further comprises: detecting a plurality of unmanned aerial systems based on the image data using a trained machine learning model; and determining a position of each of the detected unmanned aerial systems based on at least one of the image data and the position data.

In some embodiments, the method further comprises: retraining the machine learning model based on the detected unmanned aerial system and the image data.

In some embodiments, the method further comprises: transmitting the alert to at least one of a user device comprising the imaging device, a command system, and at least one user device located within a threshold distance from the position of the unmanned aerial system.

In some embodiments, the threshold distance is a user-configurable threshold.

In some embodiments, the method further comprises: generating a report comprising at least one of a location of the imaging device, a distance between the imaging device and the unmanned aerial system, an identifier associated with the imaging device, one or more images of the unmanned aerial system, and one or more confidence scores associated with the detection of the unmanned aerial system.

In some embodiments, the method further comprises: receiving a first request from a user device; and in response to receiving the request causing the user device to display the report.

In some embodiments, the method further comprises: receiving information from the user device associated with a user selection of an unmanned aerial system type from a plurality of unmanned aerial system types; and in response to receiving the additional information from the user device, updating the report with the unmanned aerial system type.

In some embodiments, the at least one imaging device comprises the user device.

In some embodiments, the method further comprises: receiving a second request from a user device; and in response to receiving the second request, causing the user device to display a map, wherein the map depicts a geographic area associated with the position of the one or more detected unmanned aerial systems.

In some embodiments, the map comprises an icon depicting the location of the imaging device.

In some embodiments, the map comprises a user selectable icon indicating a position of the one or more unmanned aerial systems.

In some embodiments, the method further comprises: receiving a third request from the user device associated with the user selectable icon, and in response to receiving the third request, causing the user device to display any one or more of: an image of the one or more unmanned aerial systems, a location of the one or more unmanned aerial systems relative to the imaging device, and temporal information associated with when the one or more unmanned aerial systems were detected.

In some embodiments, the imaging device is a mobile device.

In some embodiments, the imaging device is a surveillance camera.

An exemplary computing system comprises: one or more processors, memory, and one or more programs stored in the memory for execution by the one or more processors, the one or more programs including instructions that when executed by the one or more processors cause the system to: receive image data and position data from at least one imaging device; detect an unmanned aerial system based on the image data using a trained machine learning model; determine a position of the unmanned aerial system based on at least one of the image data and the position data; and generate an alert indicating detection of the unmanned aerial system.

An exemplary non-transitory computer-readable medium stores instructions, wherein the instructions are executable by a system comprising one or more processors to cause the system to: receive image data and position data from at least one imaging device; detect an unmanned aerial system based on the image data using a trained machine learning model; determine a position of the unmanned aerial system based on at least one of the image data and the position data; and generate an alert indicating detection of the unmanned aerial system.

In some embodiments, any one or more of the characteristics of any one or more of the systems, methods, and/or computer-readable storage mediums recited above may be combined, in whole or in part, with one another and/or with any other features or characteristics described elsewhere herein.

### BRIEF DESCRIPTION OF THE FIGURES

FIG. 1 illustrates an unmanned aerial system detection and reporting system, in accordance with some embodiments.

FIG. 2 illustrates an exemplary user interface of a mobile application for capturing images of unmanned aerial systems, in accordance with some embodiments.

FIG. 3 illustrates an exemplary user interface of a mobile application for displaying and interacting with a map overlaid with detected unmanned aerial systems, in accordance with some embodiments.

FIGS. 4A and 4B illustrate an exemplary user interface of a mobile application for displaying and interacting with reports generated based on detected unmanned aerial systems, in accordance with some embodiments.

FIG. 5 illustrates an exemplary user interface of a mobile application for displaying and interacting with a library of unmanned aerial system types.

FIG. 6 illustrates an exemplary processing engine software and communications architecture, in accordance with some embodiments.

FIG. 7 illustrates an exemplary relational database for storing data associated with detected unmanned aerial systems, in accordance with some embodiments.

FIG. 8 illustrates an exemplary method for detecting and reporting unmanned aerial systems, in accordance with some embodiments.

FIG. 9 illustrates an exemplary computing system, in accordance with some embodiments.

FIGS. 10A and 10B illustrate exemplary alerts, in accordance with some embodiments.

### DETAILED DESCRIPTION

Described herein are systems, methods, devices, and non-transitory computer readable storage media for detecting and reporting unmanned aerial systems using trained machine learning models to process image data from a distributed network of mobile and strategically positioned imaging devices. The systems and methods herein enable automated detecting, alerting, and reporting of unmanned aerial systems, allowing for efficient planning and execution of mitigation efforts. An exemplary system for detecting, reporting, and tracking unmanned aerial systems provides an end-to-end data ingestion and analysis pipeline, including a processing engine for analyzing image data received from mobile imaging devices and/or surveillance cameras to detect unmanned aerial systems, alerting users upon detection, generating reports associated with the detected unmanned aerial system, and storing data associated with the detected unmanned aerial systems.

According to some embodiments, one or more users who notice an unmanned aerial system in the area may use a mobile device, such as their personal phone, tablet, or other smart mobile devices (e.g., Android or iOS devices), to take an image or video of the unmanned aerial system. In some embodiments, the user may access a mobile application on their mobile device to capture the images and/or video and transmit the image or video, along with position data (e.g., associated with the location, bearing, and/or orientation of the mobile device), to a processing engine for analysis and detection of unmanned aerial systems based on the image data. In some embodiments, users, for instance, military or security personnel, are registered with the system, allowing them to access the mobile application with a user device. In some embodiments, the mobile application includes an image capture page that is displayed immediately upon logging into the application, which allows a user to quickly capture a photograph of a suspected unmanned aerial system from any location. Thus, each user and corresponding user device associated with the system serves as a sensor for capturing image data.

In addition to the image data provided through the mobile application, or as an alternative to such image data, video or images may be transmitted to the processing engine by a network of surveillance cameras, along with position data associated with the respective surveillance camera. The surveillance cameras may transmit the video or images to the processing engine periodically or in accordance with a triggering event. In some embodiments, the surveillance cameras continuously transmit live video to the processing engine. According to some embodiments, the processing engine processes the image data it receives from user devices and surveillance cameras to detect unmanned aerial systems based on image data.

In some embodiments, the processing engine uses one or more machine learning models, conventional algorithmic/heuristic models, and/or hybrid models analyze the image data to detect unmanned aerial systems. For instance, in some embodiments, a single machine learning model may combine both object detection and object recognition techniques (e.g., YOLO models, SSD models), and may be trained to detect objects and determine whether those objects are unmanned aerial systems. In other embodiments, separate models for object detection and recognition may be used. For example, one or more computer vision models may be configured to process the image data using object detection techniques. The object detection techniques may include conventional techniques such as edge detection, histogram equalization, and morphological operations, and/or may include machine learning models such as Convolutional Neural Networks (CNNs), Recurrent Neural Networks (RNNs), or other machine learning models trained to perform object detection. Then, following object detection performed by the computer vision models, one or more machine learning models trained to determine whether detected objects are unmanned aerial systems may process the image data. In some embodiments, the machine learning models may also be trained to determine where in the image the unmanned aerial system is, and/or a type of unmanned aerial system detected in the image, among other tasks.

In some embodiments, hybrid models may be used that combine traditional algorithms with machine learning models to create a synergistic system. Hybrid models may layer conventional algorithmic/heuristic processing pre-and post-processing techniques before and after processing based on machine learning techniques. Pre-processing of images using traditional algorithms can enhance the input for machine learning models, optimizing their performance. Post-processing of machine learning model outputs with heuristic rules might refine the results, reducing false positives or negatives. In some embodiments, the computer vision and/or machine learning models may be integral to the processing engine or may be called to process image data via third-party API's.

In some embodiments, the processing engine may also be configured to determine the position of a detected unmanned aerial system based on either or both of the image data and the position data provided by the respective imaging device. In some embodiments, the processing engine tracks detected unmanned aerial systems over time and across image data from different imaging devices. For instance, the processing engine may track movements of the unmanned aerial systems based on the image data and/or determine that an unmanned aerial system detected based on image data from a first imaging device is the same unmanned aerial system detected based on image data from a second imaging device. Tracking may be performed using heuristic and/or machine learning techniques.

The machine learning models, conventional algorithmic/heuristic models, and/or hybrid models described herein can be configured to detect unmanned aerial systems in a wide variety of environments, including crowded arenas or stadiums, critical infrastructure facilities, military bases, and so on. These environments may have a variety of differing characteristics captured in the image data submitted for analysis. For instance, image data from a stadium likely includes far more images/videos including people than image data from a critical infrastructure facility. Accordingly, in some embodiments, one or more machine learning models used to process image data described herein may be calibrated for different environments prior to deployment of the system. Calibrating the one or more machine learning models may include collecting image data from a particular environment, labeling the image data to create training data, and training the machine learning models included in a processing engine to be deployed in that respective environment. Various configurations, weighting, or other aspects of the machine learning models, conventional algorithmic/heuristic models, and/or hybrid models may additionally or alternatively be adjusted based on the environment to calibrate the respective model to the environment. Thus, the systems and methods described herein can be calibrated and optimized for any number of distinct environments.

According to some embodiments, upon detection of an unmanned aerial system, the processing engine generates outputs, including alerts and reports, and transmits the outputs to various components in communication with the processing engine. For instance, the processing engine may automatically generate an alert indicating that an unmanned aerial system has been detected and transmit the alert to user devices registered with the system. For example, an alert may be sent to registered user devices within a predefined geographical radius of the detected unmanned aerial system. The processing engine may also automatically generate a report upon detection of an unmanned aerial system that includes descriptive information about the respective unmanned aerial system such as its type, color, size or other characteristic, the device that detected it, the time and location of detection, etc. In some embodiments, the report is transmitted to the user device that captured the image including the detected unmanned aerial system, and a user can provide supplementary information to be included in the report. The report may be transmitted any device connected to the system and may be stored in one or more databases.

According to some embodiments, the processing engine also integrates information associated with a detected unmanned aerial system into a map display that can be accessed using the mobile application included on each user device. The map display may include various icons indicating, for instance, the location of the user device and the location of detected drones. Accordingly, the map display provides a comprehensive up-to-date overview of all detected unmanned aerial systems detected within their vicinity such that each user is aware of potential attack and/or surveillance threats. Thus, described herein is a system including a distributed network of imaging devices including user devices (such as mobile phones or tablets) and surveillance cameras that capture image data and feed it to a processing engine to detect and report unmanned aerial system threats using trained machine learning models.

It should be understood that any or all aspects of the processing engine may be provided on one or more of the mobile devices, surveillance cameras, on the cloud, and/or on a local server. Accordingly, any or all of the functionality described with respect to the processing engine herein may be performed at a mobile device, at one or more processors of a surveillance camera, at a local server, and/or on the cloud.

In the following description of the various embodiments, it is to be understood that the singular forms “a,” “an,” and “the” used in the following description are intended to include the plural forms as well, unless the context clearly indicates otherwise. It is also to be understood that the term “and/or” as used herein refers to and encompasses any and all possible combinations of one or more of the associated listed items. It is further to be understood that the terms “includes, “including,” “comprises,” and/or “comprising,” when used herein, specify the presence of stated features, integers, steps, operations, elements, components, and/or units but do not preclude the presence or addition of one or more other features, integers, steps, operations, elements, components, units, and/or groups thereof.

Certain aspects of the present disclosure include process steps and instructions described herein in the form of an algorithm. It should be noted that the process steps and instructions of the present disclosure could be embodied in software, firmware, or hardware and, when embodied in software, could be downloaded to reside on and be operated from different platforms used by a variety of operating systems. Unless specifically stated otherwise as apparent from the following discussion, it is appreciated that, throughout the description, discussions utilizing terms such as “processing,” “computing,” “calculating,” “determining,” “displaying,” “generating” or the like, refer to the action and processes of a computer system, or similar electronic computing device, that manipulates and transforms data represented as physical (electronic) quantities within the computer system memories or registers or other such information storage, transmission, or display devices.

The present disclosure in some embodiments also relates to a device for performing the operations herein. This device may be specially constructed for the required purposes, or it may comprise a general purpose computer selectively activated or reconfigured by a computer program stored in the computer. Such a computer program may be stored in a non-transitory, computer readable storage medium, such as, but not limited to, any type of disk, including floppy disks, USB flash drives, external hard drives, optical disks, CD-ROMs, magnetic-optical disks, read-only memories (ROMs), random access memories (RAMs), EPROMs, EEPROMs, magnetic or optical cards, application specific integrated circuits (ASICs), or any type of media suitable for storing electronic instructions, and each connected to a computer system bus.

Furthermore, the computing systems referred to in the specification may include a single processor or may be architectures employing multiple processor designs, such as for performing different functions or for increased computing capability. Suitable processors include central processing units (CPUs), graphical processing units (GPUs), field programmable gate arrays (FPGAs), and ASICs. Aspects of this disclosure may be implemented using Cloud Based Service.

The methods, devices, and systems described herein are not inherently related to any particular computer or other apparatus. Various general-purpose systems may also be used with programs in accordance with the teachings herein, or it may prove convenient to construct a more specialized apparatus to perform the required method steps. The structure for a variety of these systems will appear from the description below. In addition, the present invention is not described with reference to any particular programming language. It will be appreciated that a variety of programming languages may be used to implement the teachings of the present disclosure as described herein.

### Overview of System

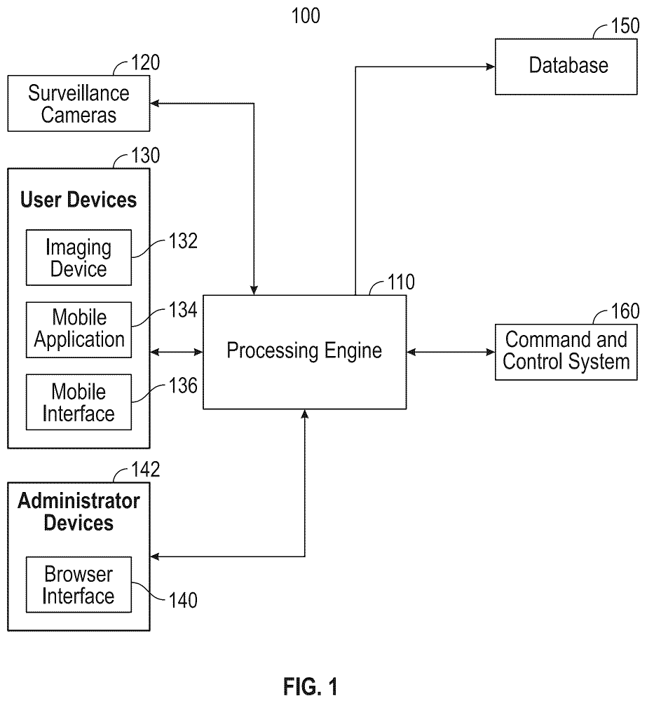

FIG. 1 illustrates an exemplary system 100. In some embodiments, system 100 includes, for example, one or more computing systems implementing a software platform for detecting, reporting, and mitigating unmanned aerial system threats, in accordance with some embodiments.

In some embodiments, the system 100 includes a plurality of imaging devices, including user devices 130 and, optionally, surveillance cameras 120 for capturing images of unmanned aerial systems. As used herein, “imaging device” is used to refer to any device capable of capturing images, including user devices (such as mobile phones or tablets) that have imaging capability and surveillance cameras (such as pan-tilt-zoom (PTZ) cameras, dome cameras, etc.). In some embodiments, the user devices 130 and/or surveillance cameras 120 are respectively in communication with a computing system, for instance, processing engine 110. The imaging devices (e.g., surveillance cameras 120 and/or user devices130) may be communicatively coupled to processing engine 110 using any communication network or combination of communication networks, such as military communication networks, ad-hoc communication networks, cellular communication networks, satellite communication networks, and so on. User devices 130 and surveillance cameras 120 may communicate with processing engine 110 using cellular service, both cellular service and Wi-Fi, Wi-Fi with internet connection, and standalone Wi-Fi without internet connection.

In some embodiments, processing engine 110 receives and processes image data and position data from the imaging devices (user devices 130 and surveillance cameras 120) through the communication network(s) and processes the image data with one or more machine learning models to detect UAVs, generate alerts and reports, and track movements of the detected UAVs. In some embodiments, the position data received by processing engine 110 includes any one or more of data corresponding to at least one of a geographic location of the at least one imaging device (e.g., surveillance camera 120 or user device 130), a bearing of the at least one imaging device, and/or an observation angle (including roll, pitch, and yaw) of the at least one imaging device. In some embodiments, the geographic location of the imaging device (e.g., surveillance camera 120 or user device 130) can be determined according to a plurality of different location services protocols. For instance, the GPS location services feature on smartphones may be used to geolocate the imaging device. Alternatively, independent Bluetooth beacons or manual user selection (e.g., via a user input on user device 130) may be used to geolocate the imaging device. In some embodiments, the bearing of the imaging device is determined based on a magnetic field sensor provided on the imaging device. In some embodiments, the observation angle/orientation (including roll, pitch, and yaw) of the imaging device is determined based on one or more accelerometers and/or gyroscopes provided on the imaging device.

In some embodiments, processing engine 110 receives image data and position data from surveillance cameras 120 and/or user devices 130 and detects unmanned aerial systems based on the image data. In some embodiments, processing engine 110 includes at least one trained machine learning model for detecting unmanned aerial systems. Upon receipt of image data and position data from surveillance cameras 120 and/or user devices 130, the processing engine may detect an unmanned aerial system based on the image data using the at least one trained machine learning model.

In some embodiments, processing engine 110 detects a plurality of unmanned aerial systems based on the image data using the at least one machine learning model. The system may detect multiple unmanned aerial systems based on image data received from a single imaging device or may detect multiple unmanned aerial systems based on image data received from a plurality of imaging devices. In some embodiments, the at least one trained machine learning model includes at least one trained classifier. In some embodiments, the at least one trained machine learning model is trained using labeled image data that includes images of unmanned aerial systems. In some embodiments, the machine learning model may be retrained based on image data received from user devices 130 and surveillance cameras 120. Accordingly, the at least one machine learning model may be continuously updated and improved based on the received image data.

In some embodiments, the processing engine 110 determines a position of the unmanned aerial system based on at least one of the image data and position data. In some embodiments, processing engine determines a distance between the at least one imaging device and the one or more unmanned aerial systems based on the image data and the position data. In some embodiments, processing engine determines an altitude of the one or more unmanned aerial systems based on the observation angle (e.g., roll, pitch, yaw) of the imaging device and the distance between the imaging device and the one or more unmanned aerial systems.

In some embodiments, the processing engine 110 tracks movement of unmanned aerial systems between multiple images received from the same imaging device and/or between multiple images received from different imaging devices. For instance, the processing engine 110 may determine a position of an unmanned aerial system based on image data received from an imaging device at a first time (T1) and store the determined position information in memory, a database, etc. The system may then receive image data from either the same device or a different imaging device at a second time (T2), and in accordance with detecting the same unmanned aerial system based on the image data received at time T2, determine an updated position of the unmanned aerial system. The system may then update the determined position information in the memory, database, etc.

In some embodiments, the processing engine 110 determines whether unmanned aerial systems detected in image data received from different imaging devices are the same unmanned aerial system or different unmanned aerial systems. In some embodiments, the processing engine 110 may detect an unmanned aerial system in image data received from a first imaging device. The system may then detect an unmanned aerial system in image data received from a second imaging device. The system may then compare one or more characteristics of the unmanned aerial system detected based on image data from the first imaging device to one or more characteristics of the unmanned aerial system detected based on image data from the second imaging device to determine whether they are the same unmanned aerial system. In accordance with determining that the unmanned aerial system detected by the first imaging device is the same unmanned aerial system detected by the second imaging device, the system may determine a more precise location of the detected unmanned aerial system based on position data from both of the respective imaging devices. In some embodiments, the system may determine that the unmanned aerial system has changed location based on the location of the first and second imaging devices. In some embodiments, the system may determine an approximate velocity of the unmanned aerial system based on the location of the first and second imaging devices and an amount of time between capture of the unmanned aerial system by the first and second imaging devices. In some embodiments, the system may store data associated with the unmanned aerial system (e.g., observed locations, temporal information) in a database.

In some embodiments, processing engine 110 may determine the type of unmanned aerial system(s) detected in the image data. In some embodiments, processing engine 110 may determine the type of unmanned aerial system using a machine learning model trained using image data including unmanned aerial systems labeled by type of unmanned aerial system. In some embodiments, processing engine 110 may determine at least one of a tactical use, a flight time capacity, a payload capacity, and a control frequency based on the type of unmanned aerial system. For instance, the processing engine may compare the determined type of unmanned aerial system to a library/database of characteristics of various unmanned aerial system types to determine tactical use, flight time capacity, payload capacity, and/or control frequency, or other characteristic of the respective unmanned aerial system type. In some embodiment, the library of characteristics of various unmanned aerial system types includes characteristics such as color, weight, dimensions, or any combination thereof.

Alternatively, in some embodiments, the type of unmanned aerial system is determined by manual user selection (e.g., via the mobile application 134 on user device 130). In some embodiments, after capturing an image of an unmanned aerial system using mobile application 134, a user selects an unmanned aerial system type from a library of unmanned aerial system types. In some embodiments, the processing engine 110 prompts a user via the mobile application 134 on a user device 130 to select a type of unmanned aerial system from a library of unmanned aerial system types. In some embodiments, various characteristics of the respective unmanned aerial system types (e.g., tactical use, flight time capacity, payload capacity, control frequency, color, weight, and/or dimensions) are stored in the library of known unmanned aerial systems and associated within the library with a respective type of unmanned aerial system. In some embodiments, a machine learning model for determining unmanned aerial system types may be retrained based on a user's selection of unmanned aerial system type.

In some embodiments, processing engine 110 generates one or more outputs based on detection of unmanned aerial systems. In some embodiments, processing engine 110 generates an alert indicating detection of an unmanned aerial system. In some embodiments, processing engine 110 transmits the alert to a user device 130 that captured the image data that processing engine 110 used to detect the unmanned aerial system. Accordingly, the processing engine 110 receives image data from a user device 130, detects one or more unmanned aerial systems based on the image data, and alerts the user of user device 130 that the images captured by the user with the respective user device 130 included one or more unmanned aerial systems. In some embodiments, processing engine 110 transmits the alert to at least one user device 130 located within a threshold distance from the position of the unmanned aerial system. In some embodiments, processing engine 110 transmits the alert to all user devices 130 connected to the system 100 and located within a threshold distance from the position of the unmanned aerial system. In some embodiments, the threshold distance is a user-configurable threshold. For instance, an administrator of the system may configure the threshold to be a specific distance (e.g., miles, kilometers, etc.) from the location of either the imaging device that captured images of the unmanned aerial system or from the determined location of the unmanned aerial system itself. Accordingly, a user of the system may set a threshold distance, and any user device registered with the system within that threshold distance may be transmitted an alert upon detection of an unmanned aerial system.

In some embodiments, the threshold may be dynamically determined and/or updated by an administrator and/or by the processing engine 110 in accordance with detection of an unmanned aerial system based on, for example, the detected type of unmanned aerial system, a velocity of the unmanned aerial system, the proximity of the detected unmanned aerial system to a military facility, critical infrastructure facility, large public gathering, etc. In some embodiments, processing engine 110 may determine that no user device 130 is located within a preconfigured threshold and may increase the threshold until a user device 130 is located within the threshold. In some embodiments, the processing engine 110 may determine that an unmanned aerial system is moving in a certain direction (e.g., North, South, East, West, etc.) and may increase the threshold in the direction of movement. In some embodiments, the processing engine 110 may decrease the threshold in the direction opposite to the unmanned aerial system's movement. The processing engine 110 can thus rapidly and automatically notify personnel within an area, which may be dynamically determined/updated by the processing engine 110 or administrators of the system, that may be under surveillance, attack, and so on, by detected unmanned aerial systems.

In some embodiments, the output is transmitted according to one or more wired or wireless communication protocols. In some embodiments, if an internet connection is unavailable, the output is transmitted via a standalone wide-area-network (WAN). In some embodiments, the output is transmitted via Firebase Cloud Messaging (FCM). Accordingly, processing engine 110 can alert all user devices 130 connected to system 100 within a certain geographical aera that an unmanned aerial system has been detected in their vicinity.

In some embodiments, processing engine 110 transmits data associated with a detected unmanned aerial system (e.g., sighting time, location, etc.) to a command-and-control system 160. Command-and-control system 160 is a multi-domain command and control system capable of detecting, tracking, and deploying countermeasures against unmanned aerial systems. In some embodiments, command-and-control system 160 is the Air Force Multi-Environmental Domain Unmanned Systems Application (MEDUSA). In some embodiments, the command-and-control system 160 is Army FAAD C2. Accordingly, upon receipt of data associated with one or more detected unmanned aerial systems, Command-and-control system 160 may deploy one or more countermeasures against the detected unmanned aerial system(s).

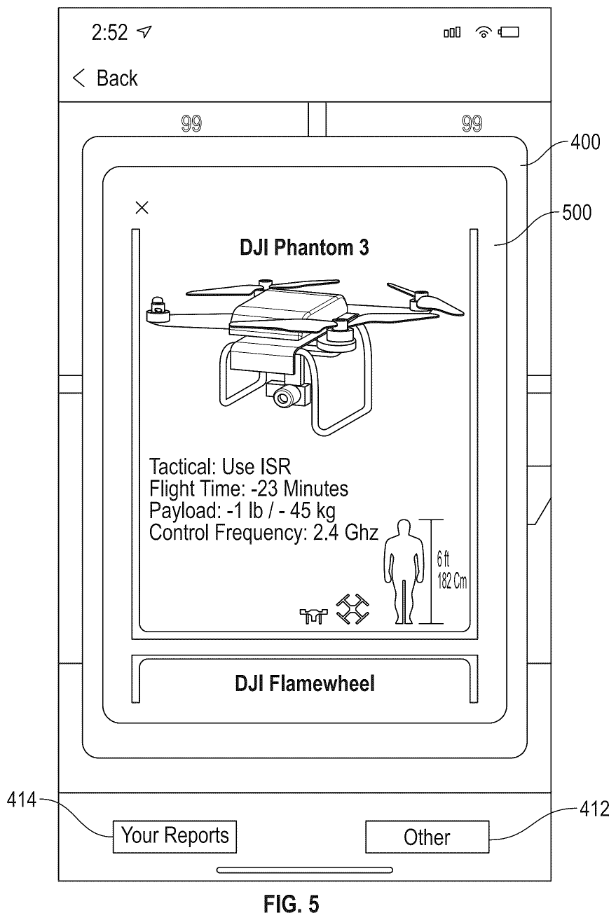

In some embodiments, processing engine 110 generates reports based on the detected unmanned aerial system(s). In some embodiments, a report generated based on detected unmanned aerial system(s) includes at least one of a location of the imaging device, a distance between the imaging device and the unmanned aerial system, an identifier associated with the imaging device, one or more images of the unmanned aerial system, and one or more confidence scores associated with the detection of the unmanned aerial system. In some embodiments, processing engine 110 transmits the generated report(s) to either of both of user devices 130 and a database 150, such as Command-and-Control Information Environment (C2IE). In some embodiments, reports are transmitted to C2IE to satisfy Combatant Commander (CCDR) Countering Unmanned Aerial Systems (CUAS) reporting requirements. In some embodiments, after generating and transmitting the report(s) to user devices 130, processing engine 110 receives additional information to be included in a report from a user device 130 that captured the image of the unmanned aerial system. For instance, a user may capture an image of a suspected unmanned aerial system with a respective user device 130 and transmit the image data to processing engine 110. Processing engine 110 may detect the unmanned aerial system and generate an initial report that is transmitted back to the user device 130 (and any other user devices 130 connected to the system). The respective user device 130 that initially captured and transmitted the image may be granted access to edit the initial report to provide supplemental data, and the modified report can then be transmitted back to processing engine 110 and pushed out to other user devices. In some embodiments, a user enters the supplemental information to be included in the report via a user interface of the user device 130, as described further below with reference to the report page 500 illustrated in FIG. 5.

In some embodiments, processing engine 110 is implemented on a computer including a 3.6 GHz, 16 core Intel® Pentium® Processor, 16 GB RAM, and NVDIA Graphics processing units (CUDA Compatible). It should be understood that a variety of other suitable computer configurations could be used to implement the processing engine. In some embodiments, user devices 130 are mobile devices (e.g., mobile phones, tablets, etc.). In some embodiments, a mobile application 134 is installed on each of the respective user devices 130. In some embodiments, a user may capture an image with a user device 130, and then transmit the image to processing engine 110 using the mobile application 134. In some embodiments, the mobile application 134 may enable a user to control the mobile device 130 to capture images of unmanned aerial systems within the mobile application 134 (i.e., to capture images using an image capture page of mobile application 134). In some embodiments, the user device 130 may enable a user to capture an image outside the mobile application 130 (e.g., using a standard camera application), and then upload the image to processing engine 110 using the mobile application 134. Accordingly, all personnel having access to the mobile application 134 can capture and report images of suspected unmanned aerial systems to processing engine 110 with a user device 130. In some embodiments, system 100 includes surveillance cameras 120. Surveillance cameras 120 may be pan-tilt-zoom (PTZ) cameras, bullet cameras, dome cameras, etc., that can be strategically positioned around a location of interest (e.g., military base, critical infrastructure facility, etc.). The surveillance cameras 120 may continuously transmit a live video feed to processing engine 110 for analysis and detection of unmanned aerial systems.

In some embodiments, system 100 includes a plurality of user interfaces, such as mobile interface 136 and browser interface 140, for controlling and displaying information related to the detection and reporting of unmanned aerial systems. User interfaces (e.g., mobile interface 136 and browser interface 140) can be displayed using one or more electronic devices, such as the one or more electronic devices. In some embodiments, mobile interface 136 is displayed using mobile application 134 on a respective mobile user device 130 such as a mobile phone or tablet. In some embodiments, browser interface 140 is displayed on one or more administrator devices 142. In some embodiments, only users with the administrator role can access and enter information into the browser interface 140. In some embodiments, mobile interface 136 and browser interface 140 may be displayed via respective displays on an electronic device such as a smart-phone or tablet, desktop computer, laptop, or any other electronic device configured to display one or more user interfaces. Mobile interface 136 and browser interface 140 be configured to receive a user input via a touch-screen or one or more other input devices alternately or additionally to a touch-screen, such as a mouse, a keyboard, one or more physical buttons or keys, voice command, etc.

In some embodiments, browser interface 140 allows a privileged user to enter new users and define new deployment locations (e.g., deployment locations of users associated with user devices 130). In some embodiments, deployment locations are associated with a military base, a critical infrastructure facility, etc. If required, the browser portal can be used to access a situational awareness display. In some embodiments, the situational awareness display shows a map of the vicinity of the user accessing the situational awareness display. In some embodiments, the situational awareness display shows all unmanned aerial system sightings reported to the processing engine 110 alongside the image that was taken at the incident location. In some embodiments, the situational awareness display is the same display as map page 300 described below and is also accessible via a user device 130 using mobile interface 136. In some embodiments, this information is accessed through a https get request to the processing engine 110.

In some embodiments, mobile application 134 includes mobile interface 136 which enables users of respective user devices 130 to interact with mobile application 134 to capture unmanned aerial system images as well as view and edit reports generated by processing engine 110. In some embodiments the mobile interface 136 associated with mobile application 134 installed on each user device 130 includes a plurality of interface pages including loading page, a login page, a QR code scanner page, an image capture page, a map page, a reports page, and an other users'reports page. In some embodiments, the loading page is the initial page that users will encounter when opening mobile application 134. It may prompt the user to give the mobile application 134 access to all sensors, for instance imaging device of user device 130, needed for the mobile application 134 to run properly. In some embodiments, until all permissions are granted, the user is not granted access to use the other functionalities of the mobile application 134. In some embodiments, in accordance with the user granting the permissions to the mobile application 134, the mobile application 134 will send the respective user's current location and token id to a database (e.g., database 112 of processing engine 110).

In some embodiments, in accordance with the user granting permissions to the mobile application 134, the mobile application 134 displays the login page. The login page may prompt the user to login, for instance, by prompting the user for a username and password, biometric verification, or by sending users to a Quick Response (QR) Code scanning page. In some embodiments, the QR Code scanning page opens a camera stream on user device 130 which allows the user to scan a QR code. The QR code may be provided by a system administrator (e.g., Personnel Support for Contingency Operations (PERSCO)). Once the QR code is scanned, the system administrator may verify the individual's identity (e.g., CAC credentials) against the registration request received via browser interface 140. It should be understood that the login process described above is exemplary and various alternative methods for logging into the application could be implemented without deviating from the scope of the disclosure.

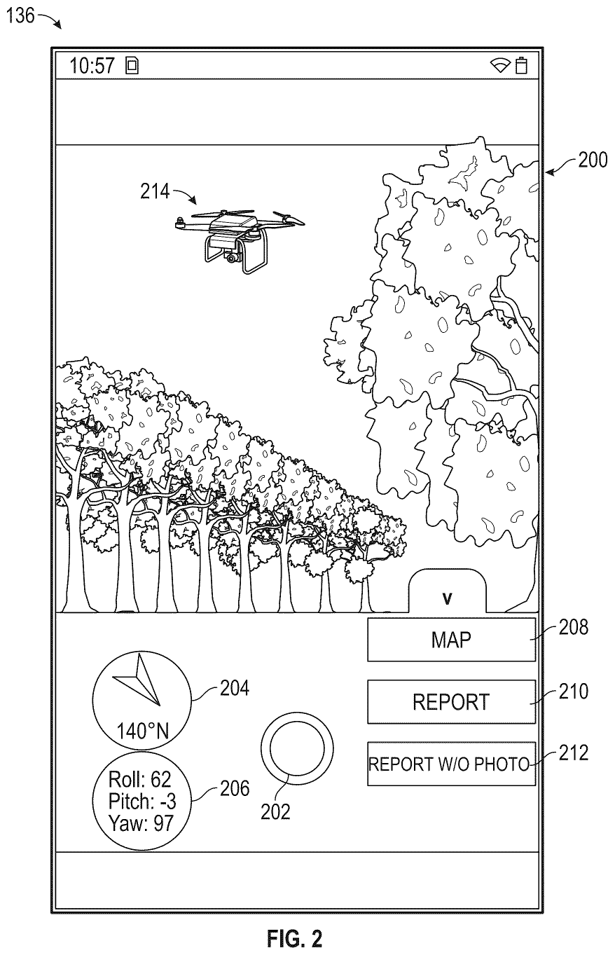

In some embodiments, in accordance with a successful login attempt, the mobile application 134 displays the image capture page on mobile interface 136. FIG. 2 illustrates an image capture page 200, according to some embodiments. In some embodiments, image capture page 200 displays a camera stream that allows a user to capture images of unmanned aerial systems for reporting. In some embodiments, image capture page 200 includes a user bearing icon 204 and/or a device orientation icon 206, which respectively display the bearing and orientation (including the roll, pitch, and yaw) of the respective user device 130. In some embodiments, data associated with the bearing and/or orientation of the user device are received from one or more sensors (e.g., accelerometers, gyroscopes, etc.) on the user device. In some embodiments, the image capture page includes a user selectable image capture icon 202. In some embodiments, in accordance with detecting a user selecting the image capture icon 202 on image capture page 200, user device 130 captures an image using imaging device 132 and transmits the image, the location of user device 130, the bearing of user device 130, and a user ID associated with user device 130 to one or both of processing engine 110 and command and control system 160. In some embodiments, the image, the location of user device 130, the bearing of user device 130, and a user ID associated with user device 130 are transmitted via a HTTPS POST request to processing engine 110, processed, and transmitted by processing engine 110 to command-and-control system 160. In some embodiments, one or more notifications associated with the information transmitted from user device 130 to processing engine 110 are displayed on mobile interface 136.

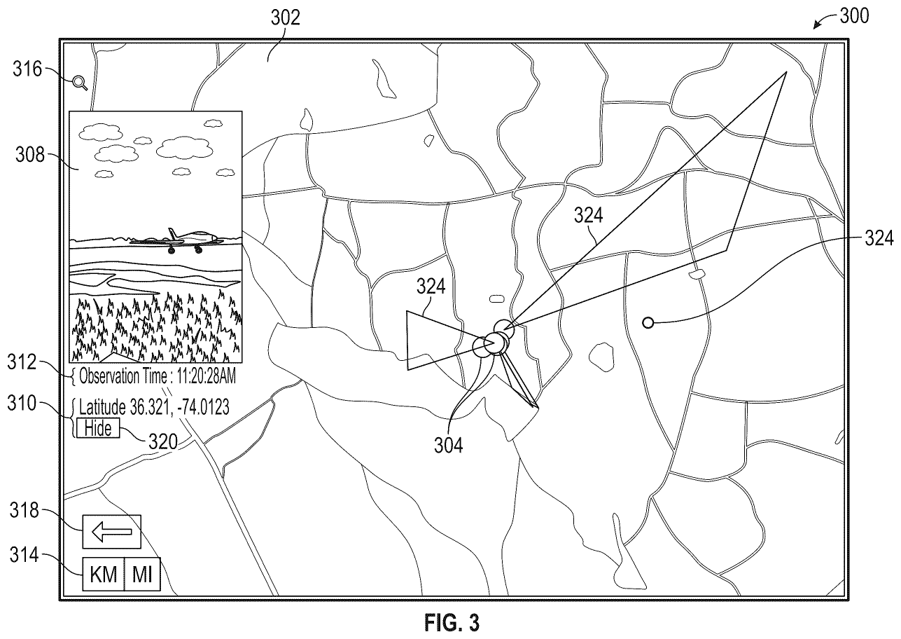

In some embodiments, image capture page 200 includes one or more additional user selectable icons, including map icon 208. In some embodiments, in response to a user selecting map icon 208, mobile application 130 displays a map page 300 on mobile interface 136. FIG. 3 illustrates a map page 300, according to some embodiments. In some embodiments, map page 300 displays a map 302 of the current location of the respective user device 130 accessing the map page 300. In some embodiments, map page 300 displays a user icon 304 associated with the current location of the respective user device 130 accessing pap page 300. In some embodiments, user icon 304 is displayed at varying levels of opacity depending on the proximity of a detected unmanned aerial system to the respective user device 130. In some embodiments, the opacity of user icon 304 is increased when unmanned aerial systems are detected in close proximity to the user device 130 relative to when unmanned aerial systems are not detected in close proximity to user device 130.

In some embodiments, the map 302 includes one or more dynamic unmanned aerial system icons 324 associated with unmanned aerial systems detected by processing engine 110 within the geographic are displayed on map 302. In some embodiments, one or more unmanned aerial system icons 324 are overlayed on map 302 at the location the respective unmanned aerial system associated with the icon 324 was detected. In some embodiments, the dynamic unmanned aerial system icons 324 are overlaid on map 302 and indicate where in a geographical space an unmanned aerial system is most likely to be (e.g., as determined by processing engine 110 as described throughout).

In some embodiments, a respective dynamic unmanned aerial system icon 324 projects from a location on map 302 associated with the location of an imaging device, which may be represented by a user icon 304. In some embodiments, the shape of the dynamic unmanned aerial system icon 324 is determined by processing engine 110 at least in part based on a distance between the unmanned aerial system and the user device associated with user icon 304. In some embodiments, an unmanned aerial system icon 324 associated with an unmanned aerial system determined to be further away from a respective imaging device may be larger than an unmanned aerial system icon 324 associated with an unmanned aerial system determined to be closer to a respective imaging device. In some embodiments, if processing engine 110 detects the same unmanned aerial system in image data from multiple imaging devices, a dynamic unmanned aerial system icon 324 may be overlayed on map 302 projecting outwardly from each of the respective user icon 304 associated with the respective imaging devices that captured the image data toward the location of the detected unmanned aerial system. In some embodiments, dynamic unmanned aerial system icons 324 projecting outwardly from each of the respective user icon 304 toward the location of the detected unmanned aerial system may overlap on map 302.

In some embodiments, the dynamic unmanned aerial system icons 324 may change in size and shape based on detection of the same unmanned aerial system in multiple images submitted by different imaging devices, the relative position of the unmanned aerial system and the respective imaging devices, and the orientation of the imaging devices. For instance, if an unmanned aerial system is detected based on image data from a single imaging device, the dynamic unmanned aerial system icon 324 may be relatively large indicating that the unmanned aerial system is likely to be found in a relatively wide a geographic area on map 302. However, if the same unmanned aerial system is detected based image data from multiple imaging devices, the size of the dynamic unmanned aerial system icon 324 may be decreased by processing engine 110 on map 302 to indicate that the unmanned aerial system is likely to be found within a smaller geographic region on the map 302, based on the relative position of the respective imaging devices that captured images of the unmanned aerial system (i.e., indicating a triangulated position of the unmanned aerial system). For instance, as shown in FIG. 3, some of the dynamic unmanned aerial system icons 324 are smaller than others, indicating that more imaging devices captured image data of the same unmanned aerial system associated with the relatively smaller icons 324 than the relatively larger icons 324. Further, as described above, the non-uniform shape of the dynamic unmanned aerial system icons 324 may be based at least in part on an orientation (e.g., roll, pitch, yaw) of the imaging device and a relative position between the detected unmanned aerial system and the imaging device.

In some embodiments, processing engine 110 may cause dynamic unmanned aerial system icons 324 to become progressively more transparent as time passes following detection of the unmanned aerial system. In some embodiments, the processing engine 110 may cause dynamic unmanned aerial system icons 324 to disappear from map 302 after a certain amount of time. Accordingly, in some embodiments, the map page 300 will cease to display respective unmanned aerial system icons 324 after an amount of time following detection of the respective unmanned aerial system associated with the icon 324. In some embodiments, the amount of time is a predefined time period between one minute and 30 minutes following detection, inclusive. In some embodiments, the amount of time is a predefined time period of 5 minutes following detection. In some embodiments, the amount of time before the dynamic unmanned aerial system icons 324 begin to change in transparency and/or the amount of time between when the dynamic unmanned aerial system icons 324 begin to change in transparency and when the dynamic unmanned aerial system icons 324 disappear from map 302 can be configured by a user and can be any amount of time selected by the user.

In some embodiments, the unmanned aerial system icons 324 are user selectable icons which, when selected, cause the map page 300 to display an image 308 of the unmanned aerial system associated with the unmanned aerial system icon 324, the location 310 of the unmanned aerial system relative to the respective user device 130, and temporal information 312 associated with when the unmanned aerial system was photographed by a user device 130/surveillance camera 120 and/or detected by processing engine 110. In some embodiments, map page 300 includes a unit icon 314 that allows a user to toggle between kilometers and miles for the unmanned aerial system location information. In some embodiments, the map page 300 includes a user selectable zoom icon 316 that allows a user to zoom in and out of the map 302 displayed on map page 300. In some embodiments, the map page 300 includes a user selectable return icon 318 that, when selected, allows a user to return to the image capture page 200.

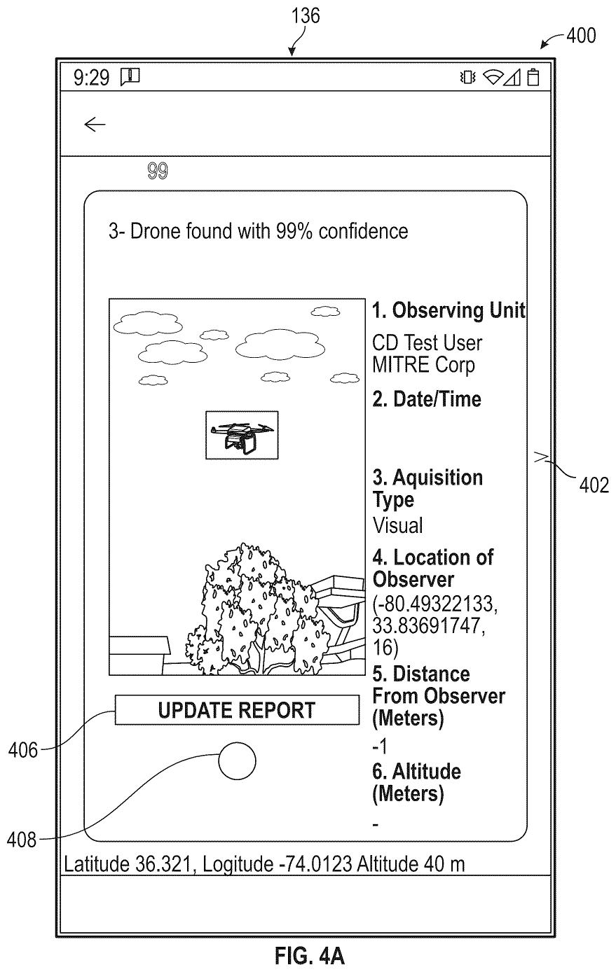

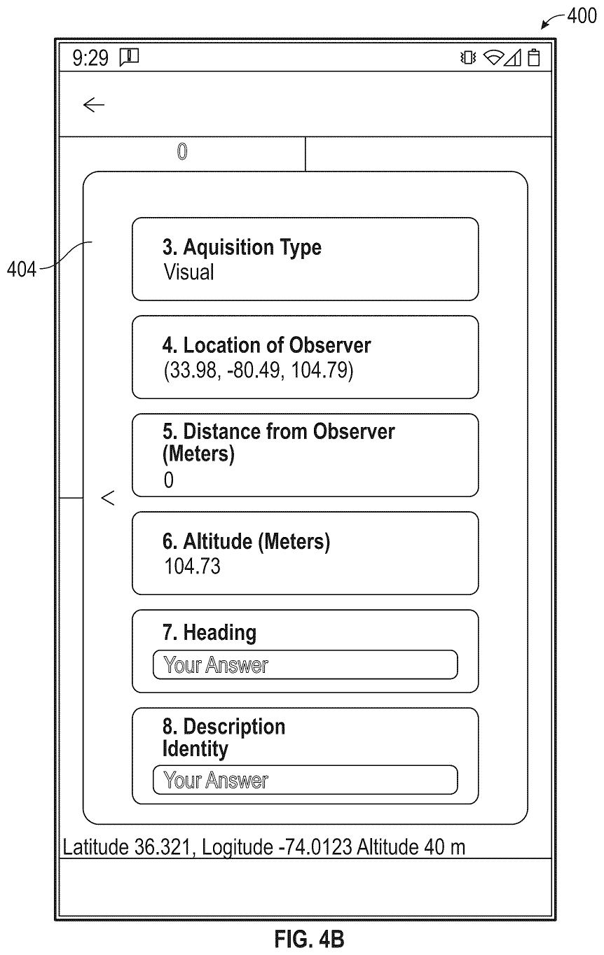

In some embodiments, the image capture page 200 includes a user selectable report icon 210. In some embodiments, in response to a user selecting report icon 210, mobile application 130 displays a report page 400 on mobile interface 136. FIG. 4A and FIG. 4B illustrates a report page 400, according to some embodiments. In some embodiments, report page 400 is configured to allow a user to scroll horizontally to view images of unmanned aerial systems captured using the imaging device 130 associated with that respective user (i.e., images that the respective user has previously captured). In some embodiments, each of the images of unmanned aerial systems displayed on report page 400 include user selectable icons 402, and in response to a user selecting a respective icon 402, a report pop-up 404, as shown in FIG. 4B, may be displayed on report page 400 including additional information associated with the unmanned aerial system. In some embodiments, the report pop-up 404 is configured to accept user inputs. In some embodiments, the user inputs may include any of a location of the imaging device, an identifier associated with the imaging device, or other information to be included in a report associated with a detected unmanned aerial system. In some embodiments, the report pop-up 404 includes a report generated by processing engine 110 based on a detected unmanned aerial system, and the report is configured to accept user inputs to edit information included in the report generated by processing engine 110. In some embodiments, report page 400 includes a user selectable update icon 406 that, when selected, causes the respective mobile device 130 to transmit an updated report to processing engine 110.

In some embodiments, the report page 400 includes a user selectable drone type icon 408 that, when selected, causes mobile application 130 to display a library 500 of known unmanned aerial system types on mobile interface 136. FIG. 5 illustrates an exemplary library 500 of known unmanned aerial system types, according to some embodiments. In some embodiments, each of the known unmanned aerial system types listed in the library 500 are configured to be user selectable such that when a user selects a respective unmanned aerial system type, it may be included in the report. For instance, the user selection may be received by processing engine 110, and processing engine may update the report to include the user selected unmanned aerial system type. In some embodiments, the unmanned aerial system type may instead be selected earlier in the process. For instance, upon capturing an image of an unmanned aerial system using mobile application 134, a user may select or input a type of unmanned aerial system and transmit the image and type of unmanned aerial system to processing engine 110.

In some embodiments, report page 400 includes a user selectable other user reports icon 412 (shown on FIG. 5). In some embodiments, in response to a user selecting other user reports icon 412, mobile application 134 displays an other user reports page (not shown) on mobile interface 136. In some embodiments, rather than using a user selectable icon, the mobile application 134 can be configured to display the other user reports page when a user scrolls horizontally on the reports page 400 displayed on mobile interface 136. In some embodiments, the other user reports page displays similar information to reports page 400, but the reports are read-only, and a user does not have access to edit the reports. In some embodiments, the reports on report page 400 and other user reports page expire and are no longer displayed by mobile application 134 after a predefined time period. In some embodiments, reports page 400 also includes a user reports icon 414 (shown on FIG. 5), which allows a user to toggle back to their own reports from the other user reports page.

Returning to FIG. 2, in some embodiments, the image capture page includes a user-selectable detection icon 212 that, when selected, may transmit an indication to processing engine 110 that a user has detected an unmanned aerial system without transmitting image data to the processing engine. Accordingly, the image capture page may enable users to report an unmanned aerial system even when the user is unable to capture an image of the unmanned aerial system.

Thus, system 100 provides an end-to-end image data ingestion and analysis pipeline for collecting image data, analyzing the image data to detect unmanned aerial system, and automatically transmitting interactive reports and alerts to personnel. The system enables continuous, distributed, monitoring and reporting of unmanned aerial system threats and rapid distribution of alerts to keep personnel informed of unmanned aerial systems in their vicinity.

### Exemplary System Software Architecture

Described below is an exemplary software architecture of the processing engine described herein. The software architecture may include a plurality of discrete software packages that function together to form the backend of a system for detecting and reporting unmanned aerial systems, including a mobile application, browser interface, and imaging devices. It should be understood that the software architecture description is meant to be exemplary and various modifications could be made without deviating from the scope of the disclosure.

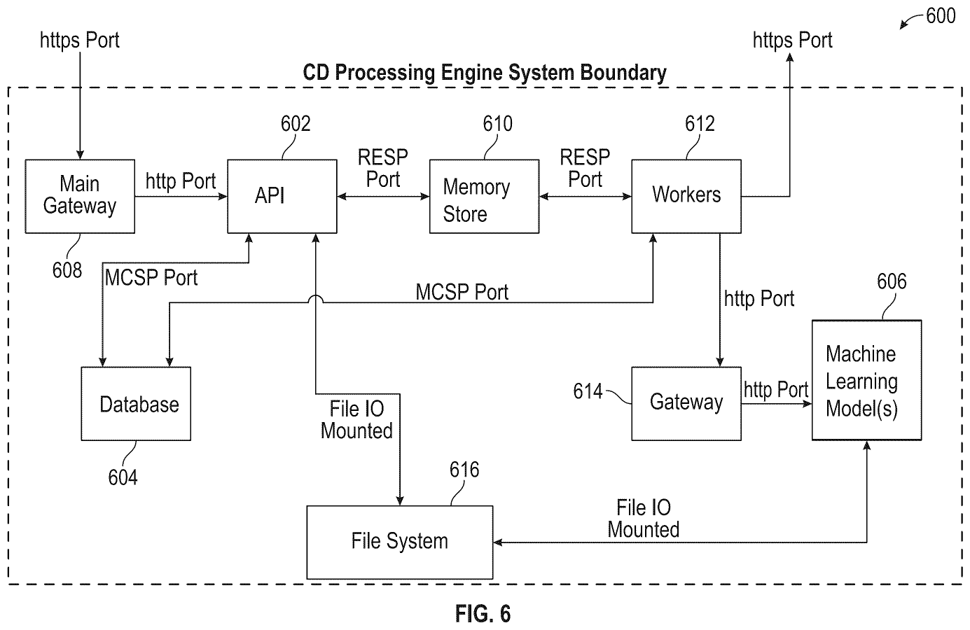

FIG. 6 illustrates an exemplary software architecture 600 for one or more processors configured to detect and report unmanned aerial systems, such as one or more processors of processing engine 110 described above with reference to FIG. 1. In some embodiments, the software architecture 600 includes API 602, which serves as the endpoint for the frontend software (e.g., mobile interface 136 of mobile application 134 and browser interface 140) to communicate with the backend processing. In some embodiments, API 602 is a Flask API implemented in python Flask, a web microframework. API 602 serves endpoints that can be used to retrieve information from other components of the processing engine 110, such as the database 604 and the machine learning model(s) 606. In some embodiments, API 602 routes communications from Main Gateway 608 (described below) to different processing engine components using different communication protocols, as described below.

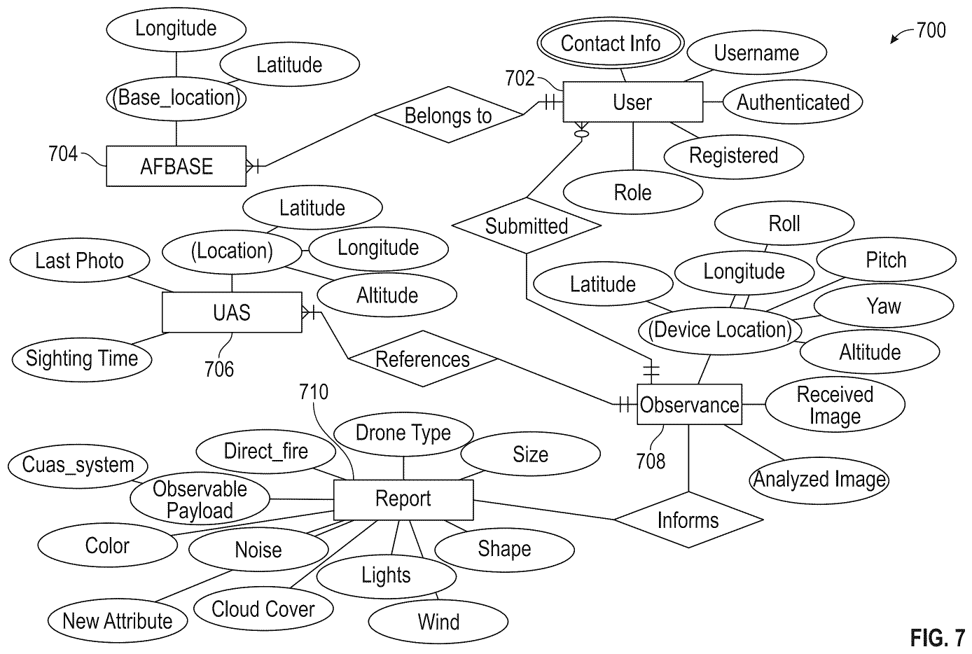

In some embodiments, software architecture 600 includes database 604, which serves as the main data store of the system. In some embodiments, database 604 communicates directly with API 602 using a client/server protocol (TCP/IP). In some embodiments, database 604 communicates directly with API 602 using a MariaDB client/server protocol (TCP/IP). In some embodiments, database 604 stores observations (e.g., images of unmanned aerial systems) sent in by the users. For instance, database 604 may store images captured by user devices 130, modified reports transmitted to processing engine using mobile application 134 (e.g., after a unmanned aerial system detection report has been modified by a user associated with a respective user device 130). In some embodiments, database 604 may store location data associated with a user device 130 or surveillance camera 120 and/or an unmanned aerial system detected based on image and position data provided by a user device 130 or surveillance camera 120. In some embodiments, database 604 stores results of the machine learning model, for instance machine learning model 606 described below, used to detect unmanned aerial systems based on image data captured by a user device 130 or surveillance camera 120. In some embodiments, database 604 stores user credentials, such as usernames, passwords, biometric data, or other credentials associated with respective authorized users of the systems described herein. In some embodiments, database 604 is a MariaDB database. Further detail on the graph structure of database 604 is provided below with reference to FIG. 7.

In some embodiments, software architecture 600 includes at least one trained machine learning model 606. In some embodiments, the at least one trained machine learning model 606 is trained using labeled image data. In some embodiments, the labeled image data includes one or more unmanned aerial systems. In some embodiments, the at least one machine learning model 606 includes a trained classifier. In some embodiments, the at least one trained machine learning model includes a Detectron2 module. A Detectron2 module is an open-source machine learning model. In some embodiments, the Detectron2 module is trained to detect unmanned aerial systems based on image data. In some embodiments, the Detectron2 module is implemented in python Flask and is only used for image processing. In some embodiments, multiple Detectron2 modules can be included in software architecture 600 to account for varying system loads. It should be understood that various alternative or additional machine learning/computer vision models to the Detectron2 modules described herein could be used to detect unmanned aerial systems as described throughout.

In some embodiments, software architecture 600 includes Main Gateway 608 for interfacing with the external network (i.e., external to the processing engine 110). In some embodiments, Main Gateway 608 is a pre-packaged nginx docker image that has a custom configuration for the systems and methods described herein. In some embodiments, Main Gateway 608 takes a https traffic and converts it to http traffic before routing to API 602 so that the main API 602 does not have to process Secure Sockets Layer (SSL) encryption. Additionally, the main gateway also serves as a cache, storing and serving repeated API calls that do not require processing from API 602.

In some embodiments, software architecture 600 includes memory store 610, which serves as an in-memory data structure store. In some embodiments, the memory store 610 is a Redis in-memory data structure store. In some embodiments, memory store 610 is used as a task queue manager. In some embodiments, memory store 610 stores the tasks that the API 602 creates and makes the tasks available to Workers 612. In some embodiments, Workers 612 are software configured to perform tasks in a task queue. In some embodiments, the task queue is an asynchronous/distributed task queue, such as Celery. In some embodiments, Workers 612 are Celery Workers. API 602 may interact with the memory store 610, and the memory store 610 may interact with Workers 612 using the same communication protocol. In some embodiments, API 602 may interact with the memory store 610 via a Redis Serialization Protocol (TCP/IP), and the memory store 610 may interact with Workers 612 using the same communication protocol. In some embodiments, Workers 612 perform long-running processes such as querying a machine learning model 606. A long-running process is a process that consumes a significant amount of server resources and/or time. When the API 602 receives an API call, if the API call is a long-running process, it delegates the work to the Workers 612 for asynchronous processing. By delegating long running tasks to the Workers 612, the main API 602 can avoid blocking API calls or delaying processing. In some embodiments, Workers 612 also communicate directly with database 604, using a client/server protocol (TCP/IP) such as a MariaDB client/server protocol (TCP/IP), for instance, to store results of tasks delegated to the Workers 612.

In some embodiments, software architecture 600 includes a Gateway 614, which sits between the Flask API 602 and the machine learning models 606 to balance loads across multiple models, for instance across multiple Detectron2 modules. In some embodiments, the Gateway 614 routes communications between Workers 612 and respective machine learning models 606 (e.g., Detectron2 modules) using an http (TCP/IP) protocol. In some embodiments, Gateway 614 is a pre-packaged nginx docker image with a custom configuration file. Unlike to the Main Gateway 608, the Gateway 614 does not interface with the external network. Gateway 614 coordinates which jobs should be passed to which instance of the machine learning models 606 (e.g., Detectron2 modules), and simplifies the communication to the API 602, so that the API 602 does not have to keep track of the multiple machine learning models 606.

In some embodiments, software architecture 600 includes File System 616, which contains the images that are passed between the API 602 and the machine learning model(s) 606. In some embodiments, File System 616 store images sent in from users as well as images resulting from the analysis by the machine learning algorithm. In some embodiments, the images are named and referenced by an auto-generated universally unique identifier (UUID). The database stores references to the images as a path. In some embodiments, each image is assigned a unique 32-digit hex string as a file name, corresponding to the event that generated the image. In some embodiments, API 602 writes into a received_images folder of File System 616 when an image is received (e.g., from user devices 130 or surveillance cameras 120), then a machine learning model 606 (e.g., Detectron2 module) will read that image, run the machine learning algorithm, such as the Detectron2 algorithm, on the image, and write to the analyzed_images folder of FileSystem 616.

In some embodiments, the machine learning model(s) 606 as well as configuration files may be stored in the File System 616. The configuration files may be stored in a Config folder. The Config folder contains YAML files that define the configurations to be used for model inference (i.e., how the machine learning models are configured to make predictions). In some embodiments, a weights folder contains the serialized pre-trained models which are loaded on runtime of the machine learning model(s) 606. In some embodiments, the File System 616 also includes security protocol files and source code.

### Exemplary Relational Database Architecture

FIG. 7 illustrates an exemplary database graph structure 700 for database 604, in accordance with some embodiments. In some embodiments, database 604 is a relational database that includes different tables for different categories of information. In some embodiments, each table is represented in the graph structure 700 by a node. Each node representing a table is linked by edges to nodes representing data stored in the respective table, as well as to nodes representing other tables in the graph structure 700. In some embodiments, the edges define relationships between the nodes. In some embodiments, the relationships include logical (e.g., not, must, etc.), hierarchical (e.g., belongs to, etc.), and process relationships (e.g., references, informs, submitted, etc.). In some embodiments, a user table 702 includes usernames, unit names associated with the respective users, contact information associated with the respective users, user roles associated with respective users, and whether respective users are authenticated and/or registered. For instance, user roles may include administrative roles, which are users granted administrative privileges to add new users and new bases to the system. User roles may also include general user roles, which are users with privileges limited to reporting unmanned aerial system sightings using mobile application 134.

In some embodiments, database graph structure 700 includes an AFBASE table 704 which stores the name of the processing engine 110 associated with respective users. In some embodiments, the AFBASE table 704 is linked by an edge of a graph structure to user table 702. In some embodiments, the edge represents that users in the user table 702 belong to a respective base associated with AFBASE table 704. For instance, each base (e.g., military base, critical infrastructure facility, etc. may have a dedicated processing engine 110 for receiving and processing image data from user devices 130 and surveillance cameras 120 located at that respective base. The AFBASE table 704 may store associations between users of the system and the respective bases at which they are stationed. In some embodiments, AFBASE table 704 includes information associated with the location (e.g., latitude and longitude) of a respective base.

In some embodiments, database graph structure 700 includes an unmanned aerial system table 706 that stores information associated with detected unmanned aerial systems. In some embodiments, unmanned aerial system table 706 includes data associated with sighting times, images, and locations of respective unmanned aerial systems detected by processing engine 110. In some embodiments unmanned aerial system table is linked by a edge to an observance table 708 and references data stored in the observance table.

In some embodiments, the observance table 708 stores data associated with images including unmanned aerial systems submitted by user devices 130 and surveillance cameras 120. In some embodiments, the observance table 708 includes data associated with device locations (e.g., of user devices 130 and surveillance cameras 120). For instance, the data associated with device locations may include latitude, longitude, altitude, roll, pitch, and yaw information. In some embodiments, the observance table also includes data associated with receives images and analyzed images (i.e., images analyzed by one or more machine learning models 606). In some embodiments observance table 708 is linked by an edge to user table 702 within database graph structure 700 associating users with observances (i.e., unmanned aerial system images) submitted by users and respective user devices 130.

In some embodiments, database graph structure 700 includes a report table 710 that is linked by an edge of the graph structure to observance table 708 and is informed by data stored in the observance table. In some embodiments, report table 710 includes information included in reports generated by processing engine 110 for each detected unmanned aerial system. In some embodiments, report table includes data associated with any of a type, size, shape, lights, observable payload, color, noise, CUAS system, and direct fire (an indication that the subject drone has shot any form of projectile at a target) associated with a detected unmanned aerial system. In some embodiments, report table 710 includes cloud cover and wind data associated with associated with a detected unmanned aerial system.

Accordingly, the systems and methods described herein may implement one or both of a custom software architecture and a custom relational database for detecting and reporting unmanned aerial systems. Below is a description of a process for receiving image data, detecting unmanned aerial systems using machine learning models, and generating outputs including reports and alerts that may implement any of the system components described above with reference to FIGS. 1-7.

### Method for Detecting and Reporting Unmanned Aerial Systems

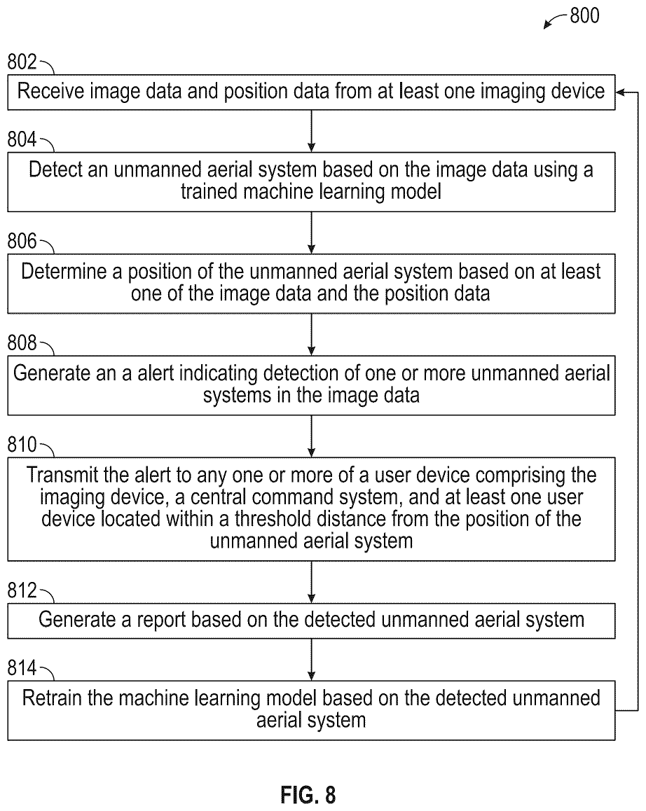

FIG. 8 illustrates an exemplary process 800 for detecting unmanned aerial systems, generating alerts indicating detecting of the unmanned aerial systems, and transmitting the alerts to one or more electronic devices, in accordance with some embodiments. The exemplary process illustrated in FIG. 8 may be performed using any combination of the components described above with reference to FIGS. 1-7.

Process 800 is performed, for example, by a computing system implementing a software platform. In process 800, some blocks are, optionally, combined, the order of some blocks is, optionally, changed, and some blocks are, optionally, omitted. In some examples, additional steps may be performed in combination with the process 800. Accordingly, the operations as illustrated (and described in greater detail below) are exemplary by nature and, as such, should not be viewed as limiting.

At block 802, an exemplary computing system (e.g., processing engine 110 of FIG. 1) receives image data and position data from at least one imaging device. In some embodiments, the at least one imaging device includes either or both of user devices and surveillance cameras. In some embodiments, the image data may include one or more images or videos. In some embodiments, the image data includes one or more images of one or more unmanned aerial systems. In some embodiments, the position data includes data corresponding to at least one of a geographic location of the imaging device, a bearing of the imaging device, and/or an observation angle/orientation (including roll, pitch, and yaw) of the imaging device. In some embodiments, the geographic location of the imaging device (e.g., surveillance camera 120 or user device 130) can be determined according to a plurality of different location services protocols. For instance, the GPS location services feature on smartphones may be used to geolocate the imaging device. Alternatively, independent Bluetooth beacons or manual user selection (e.g., via a user input on user device 130) may be used to geolocate the imaging device. In some embodiments, the bearing of the imaging device is determined based on a magnetic field sensor provided on the imaging device. In some embodiments, the observation angle/orientation (including roll, pitch, and yaw) of the imaging device is determined based on one or more accelerometers and/or gyroscopes provided on the imaging device. The position data of the imaging device can be used by the system in combination with the image data to determine a position of the unmanned aerial system, which can allow the system to alert personnel near the detected unmanned aerial system of its presence.

In some embodiments, the user devices are mobile devices such as smart phones, tablets, or other mobile devices. In some embodiments, a mobile application is installed on each user device that allows the device to connect to the system. In some embodiments, the mobile application includes any of the features described above with reference to FIG. 1-5. In some embodiments, a user of the user device can open the mobile application and capture image data using an image capture function of the mobile application. Accordingly, each user device, and in turn, each user, becomes a sensor for detection and reporting of unmanned aerial systems. In some embodiments, the imaging devices include surveillance cameras (e.g., pan-tilt-zoom (PTZ) cameras, bullet cameras, dome cameras), which may be strategically positioned at various locations to respectively capture a video. As such, the system may include imaging devices operated by users of mobile devices through a custom mobile application which can be used to capture and report images of unmanned aerial system from wherever the user is located, as well as a plurality of surveillance cameras which can be strategically positioned about a location of interest to collect and transmit a video feed (including a continuously transmitted live-video stream) for detection of unmanned aerial systems near the location of interest. In some embodiments, the imaging devices transmit image data associated with the captured images and/or video to the system for processing.

At block 804, the system may detect an unmanned aerial system based on the image data using a trained machine learning model. In some embodiments, the system determines the type (or types) of unmanned aerial system detected based on the image data using a trained machine learning model. In some embodiments, the system determines one or more payloads of the unmanned aerial system using a trained machine learning model. In some embodiments, the system determines any of a color, size, type, or direction of travel using a trained machine learning model. In some embodiments, the trained machine learning model includes at least one classifier. In some embodiments, the trained machine learning model is trained using labeled image data, and wherein the labeled image data includes one or more unmanned aerial systems. In some embodiments, the labeled image data includes one or more payload types (e.g., imaging systems, weapons systems, etc.). In some embodiments, the labeled training data includes any of a color, size, type, or direction of travel of one or more unmanned aerial systems. In some embodiments, the system detects a plurality of unmanned aerial systems based on the image data using a machine learning model. The system may detect multiple unmanned aerial systems based on image data received from a single imaging device or may detect multiple unmanned aerial systems based on image data received from a plurality of imaging devices. Alternatively, in some embodiments, the system may receive a user input indicating a selected type of unmanned aerial system. For instance, a user may be prompted by a mobile application used to transmit the image data to the computing system to select a type of unmanned aerial system. Based on the type, the system may determine various characteristics/features of the unmanned aerial system, such as dimensions (e.g., size), color, weight, etc. of the unmanned aerial system based on a database storing types of unmanned aerial systems respectively associated with a variety of features/characteristics. Alternatively, in some embodiments, the received user input may include the features such as dimensions (e.g., size), color, weight along with the type.

In some embodiments, based on the type of unmanned aerial system, the system determines at least one of a tactical use, a flight time capacity, a payload capacity, and a control frequency of the unmanned aerial system. The system may determine the flight time capacity, payload capacity, and control frequency based on a database storing types of unmanned aerial systems associated with the flight time capacity, payload capacity, and control frequency of the respective unmanned aerial system. For instance, the system may determine that the detected unmanned aerial system is a DJI Phantom 3 with an Intelligence, Surveillance, and Reconnaissance (ISR) tactical use, approximately 23 minutes of flight time capacity, a payload capacity of approximately 1 pound, and a control frequency of 2.4 GHz. Based on the determined tactical use, a flight time capacity, a payload capacity, and a control frequency the system may generate recommended countermeasures for mitigating any threats posed by the detected unmanned aerial systems. In some embodiments, the system may automatically deploy the recommended countermeasures.

At block 806, the system may determine a position of the unmanned aerial system based on at least one of the image data and the position data. In some embodiments, the system determines a distance between the at least one imaging device and the one or more unmanned aerial systems based on the image data and the position data. For instance, the system may determine a size of the detected unmanned aerial system as described above and determine a distance between the imaging device and the unmanned aerial system based on the size of the unmanned aerial system and a resolution of the imaging device. In some embodiments, the resolution of the imaging device may be transmitted by the respective imaging device to the computing system along with the image data and position data. In some embodiments, the system may determine a position of the imaging device based on the position data, determine a size of the unmanned aerial system based on the image data, and determine a position of the unmanned aerial system based on the position of the imaging device and the size of the unmanned aerial system. In some embodiments, the imaging device may be a rangefinder camera that determines the distance between the imaging device and the unmanned aerial system in the image and transmits the distance information to the computing system. In some embodiments, the system determines an altitude of the one or more unmanned aerial systems based on the orientation (e.g., roll, pitch, yaw) of the imaging device and the distance between the imaging device and the one or more unmanned aerial systems.

In some embodiments, the system determines whether unmanned aerial systems detected based on image data received at different times and/or from different imaging devices are the same unmanned aerial system or different unmanned aerial systems. In some embodiments, the system may detect an unmanned aerial system based on first image data received from a first imaging device. The system may then detect an unmanned aerial system based on second image data received from the same imaging device at a later time or from a second imaging device. The system may compare one or more characteristics/features of the unmanned aerial system detected based on the first image data to one or more characteristics/features of the unmanned aerial system detected based on the second image data to determine whether they are the same unmanned aerial system. In some embodiments, the system may compare characteristics/features associated with the unmanned aerials system's color, type, dimensions, payload, or location to determine whether the unmanned aerial systems detected in the first and second image data are the same or different. In some embodiments, the system may also consider the proximity between two respective imaging devices and/or the direction of travel (i.e., heading) of the unmanned aerial system in determining whether the detected unmanned aerial system in the first and second image data is likely the same unmanned aerial system.

In some embodiments, the system may determine whether the same unmanned aerial system is detected across any number of imaging devices associated with the system. In accordance with determining that an unmanned aerial system detected by a plurality of imaging devices is the same unmanned aerial system, the system may determine a more precise location of the detected unmanned aerial system based on position data from all, or a subset of all, of the respective imaging devices. In some embodiments, the system may determine that the unmanned aerial system has changed location based on the location the respective imaging devices that detected the same unmanned aerial system. In some embodiments, the system may determine an approximate velocity of the unmanned aerial system based on the location of a first and second imaging device and an amount of time between the capture of images of the unmanned aerial system by the first and second imaging devices. In some embodiments, the system determines a predicted trajectory of the tracked unmanned aerial system based on the location of the all or a subset of all of the imaging devices that captured images of the same unmanned aerial system. In some embodiments, the system may store data associated with the unmanned aerial system (e.g., observed locations, temporal information) in a database.

In some embodiments, the system tracks movement of unmanned aerial systems between multiple images received from the same imaging device and/or between multiples images received from different imaging devices. For instance, the system may determine a position of an unmanned aerial system based on image data and/or position data received from an imaging device at a first time (T1) and, optionally, store the determined position information in memory, a database, etc. The system may then receive image data and position data from either the same device or a different imaging device at a second time (T2), and in accordance with detecting the same unmanned aerial system based on the image data received at time T2, determine an updated position of the unmanned aerial system. The system may then update the determined position information in the memory, database, etc. As such, the system may track detected unmanned aerial systems based on image data received at different times and across different imaging devices.

At block 808, the system may generate one or more outputs based on detection of an unmanned aerial system. In some embodiments, the system generates an alert indicating detection of the unmanned aerial system. In some embodiments, the alert is any combination of an audio alert, a haptic alert, and/or a visual alert. In some embodiments, the system transmits the generated alert the user device that captured the image based upon which the unmanned aerial system was detected, a command system, and at least one user device located within a threshold distance from the position of the unmanned aerial system. In some embodiments, the threshold distance is a user-configurable threshold. For instance, an administrator of the system may configure the threshold to be a specific distance (e.g., miles, kilometers, etc.) from the location of either the imaging device that captured images of the UAV or from the determined location of the UAV itself. Accordingly, a user of the system may set a threshold distance, and any user device registered with the system within that threshold distance may be transmitted an alert upon detection of an unmanned aerial system.

In some embodiments, the threshold may be dynamically determined and/or updated by an administrator and/or by the computing system in accordance with detection of an unmanned aerial system based on, for example, the detected type of unmanned aerial system, a velocity of the unmanned aerial system, the proximity of the detected unmanned aerial system to a military facility, critical infrastructure facility, large public gathering, etc. In some embodiments, the system may determine that no user device is located within a preconfigured threshold, and may increase the threshold until a user device is located within the threshold. In some embodiments, the system may determine that an unmanned aerial system is moving in a certain direction (e.g., North, South, East, West, etc.) and may increase the threshold in the direction of movement. In some embodiments, the system may decrease the threshold in the direction opposite to the unmanned aerial system's movement. The system can thus rapidly and automatically notify personnel within an area, which may be dynamically determined/updated by the system or administrators of the system, that may be under surveillance, attack, and so on, by detected unmanned aerial systems. In some embodiments, the alert may indicate that an unmanned aerial system may be approaching their location based on a trajectory of the unmanned aerial system determined at block 806.

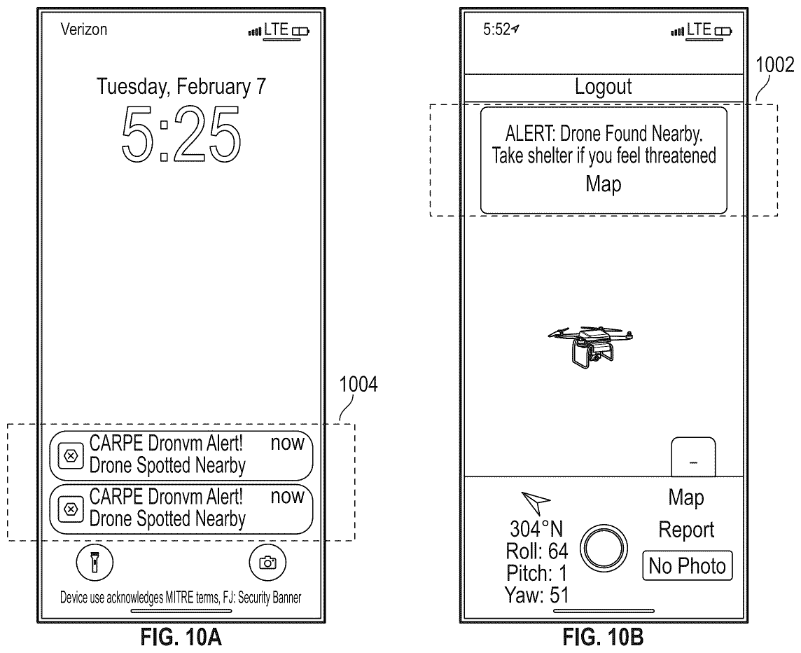

In some embodiments, the alert may be displayed differently depending on whether a user device is logged into the custom mobile application associated with the system. If the user device is not logged into the mobile application, the alert may be displayed at the top of the mobile device screen (e.g., as a banner notification), as shown in alert 1002 illustrated in FIG. 10A. If the user device is logged into the mobile application, the alert may be displayed in the center of the screen of the user device, as shown in alerts 1004 illustrated in FIG. 10B. The alert may be emphasized relative to other aspects of the mobile application, for instance, using a specific color or boundary box to distinguish the alert. In some embodiments, the alert is displayed in a red boundary box.

At block 812, the system may generate a report including at least one of a location of the imaging device, a distance between the imaging device and the unmanned aerial system, an identifier associated with the imaging device, one or more images of the unmanned aerial system, and one or more confidence scores associated with the detection of the unmanned aerial system. In some embodiments, the system receives supplemental information to be included in a report from a user device that captured an image of an unmanned aerial system via an input provided on the mobile application. For instance, a user may capture an image of a suspected unmanned aerial system with a respective user device and transmit the image data to a processing engine. The processing engine may detect the unmanned aerial system and generate an initial report that is transmitted back to the user device (and any other user devices connected to the system). The respective user device that initially captured and transmitted the image may be granted access to edit the initial report to provide supplemental data, including a selection of an unmanned aerial system type, and the modified report can then be transmitted back to the processing engine and pushed out to other user devices. In some embodiments, a user enters the supplemental information to be included in the report via a user interface of the user device, as described above with reference to the report page 500 illustrated in FIG. 5. In some embodiments, the generated report(s) are transmitted to either of both of user devices and C2IE. In some embodiments, reports are transmitted to C2IE to satisfy Combatant Commander (CCDR) Countering Unmanned Aerial Systems (CUAS) reporting requirements.

In some embodiments, the report is displayed on a report page of a mobile application in the same manner described above with reference to FIGS. 1-5. In some embodiments, the report is displayed on an interactive user interface configured to receive user inputs to navigate to various pages of the display. For instance, in accordance with receiving a user input, the system may cause a user device displaying the interface to display a map, wherein the map depicts a geographic area associated with the position of the one or more detected unmanned aerial systems. In some embodiments, the map comprises an icon depicting the location of the imaging device. In some embodiments, the map comprises a user selectable icon indicating a position of the one or more unmanned aerial systems. In some embodiments, in accordance with receiving a user selection of the user selectable icon indicating a position of the one or more unmanned aerial systems, the system causes the user device to display any one or more of: an image of the one or more unmanned aerial systems, a location of the one or more unmanned aerial systems relative to the imaging device, and temporal information associated with when the one or more unmanned aerial systems were detected.

Optionally, at block 814, the machine learning application may be retrained based on image data including detected unmanned aerial systems. Accordingly, the machine learning models may be continuously updated and improved using image data captured by the mobile user devices and surveillance cameras.

### Exemplary Computing Device

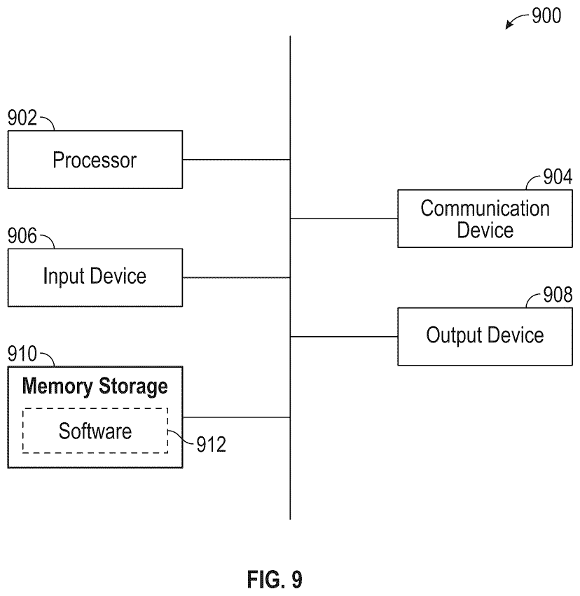

FIG. 9 depicts an exemplary computing device 900, in accordance with one or more examples of the disclosure. Device 900 can be a host computer connected to a network. Device 900 can be a client computer or a server. As shown in FIG. 9, device 900 can be any suitable type of microprocessor-based device, such as a personal computer, workstation, server, or handheld computing device (portable electronic device) such as a phone or tablet. The device can include, for example, one or more of processors 902, input device 906, output device 908, storage 910, and communication device 904. Input device 906 and output device 908 can generally correspond to those described above and can either be connectable or integrated with the computer.

Input device 906 can be any suitable device that provides input, such as a touch screen, keyboard or keypad, mouse, or voice-recognition device. Output device 908 can be any suitable device that provides output, such as a touch screen, haptics device, or speaker.

Storage 910 can be any suitable device that provides storage, such as an electrical, magnetic, or optical memory, including a RAM, cache, hard drive, or removable storage disk. Communication device 904 can include any suitable device capable of transmitting and receiving signals over a network, such as a network interface chip or device. The components of the computer can be connected in any suitable manner, such as via a physical bus or wirelessly.

Software 912, which can be stored in storage 910 and executed by processor 902, can include, for example, the programming that embodies the functionality of the present disclosure (e.g., as embodied in the devices as described above).

Software 912 can also be stored and/or transported within any non-transitory computer-readable storage medium for use by or in connection with an instruction execution system, apparatus, or device, such as those described above, that can fetch instructions associated with the software from the instruction execution system, apparatus, or device and execute the instructions. In the context of this disclosure, a computer-readable storage medium can be any medium, such as storage 910, that can contain or store programming for use by or in connection with an instruction execution system, apparatus, or device.

Software 912 can also be propagated within any transport medium for use by or in connection with an instruction execution system, apparatus, or device, such as those described above, that can fetch instructions associated with the software from the instruction execution system, apparatus, or device and execute the instructions. In the context of this disclosure, a transport medium can be any medium that can communicate, propagate, or transport programming for use by or in connection with an instruction execution system, apparatus, or device. The transport readable medium can include, but is not limited to, an electronic, magnetic, optical, electromagnetic, or infrared wired or wireless propagation medium.

Device 900 may be connected to a network, which can be any suitable type of interconnected communication system. The network can implement any suitable communications protocol and can be secured by any suitable security protocol. The network can comprise network links of any suitable arrangement that can implement the transmission and reception of network signals, such as wireless network connections, T1 or T3 lines, cable networks, DSL, or telephone lines.

Device 900 can implement any operating system suitable for operating on the network. Software 912 can be written in any suitable programming language, such as C, C++, Java, or Python. In various embodiments, application software embodying the functionality of the present disclosure can be deployed in different configurations, such as in a client/server arrangement or through a Web browser as a Web-based application or Web service, for example.

Although the disclosure and examples have been fully described with reference to the accompanying figures, it is to be noted that various changes and modifications will become apparent to those skilled in the art. Such changes and modifications are to be understood as being included within the scope of the disclosure and examples as defined by the claims. Finally, the entire disclosure of the patents and publications referred to in this application are hereby incorporated herein by reference.

1. A method for generating one or more alerts based on the detection of one or more unmanned aerial systems, the method comprising:
receiving image data and position data from at least one imaging device;
detecting an unmanned aerial system based on the image data using a trained machine learning model;
determining a position of the unmanned aerial system based on at least one of the image data and the position data; and
generating an alert indicating detection of the unmanned aerial system.

2. The method of claim 1, wherein the position data comprises data corresponding to at least one of a geographic location of the at least one imaging device, a bearing of the at least one imaging device, and an observation angle of the at least one imaging device.

3. The method of claim 1, further comprising: determining a distance between the at least one imaging device and the one or more unmanned aerial systems based on the image data and the position data.

4. The method of claim 3, further comprising: determining an altitude of the one or more unmanned aerial systems based on the observation angle of the imaging device and the distance between the imaging device and the one or more unmanned aerial systems.

5. The method of claim 1, further comprising: determining a type of the unmanned aerial system based on the image data.

6. The method of claim 5, further comprising: determining at least one of a tactical use, a flight time capacity, a payload capacity, and a control frequency based on the type of unmanned aerial system.

7. The method of claim 1, further comprising: tracking an unmanned aerial system based on the image data and the position data from a first imaging device and the image data and the position data from a second imaging device.

8. The method of claim 1, wherein determining a position of the unmanned aerial system based on at least one of the image data and the position data comprises:
determining a position of the unmanned aerial system based on at least one of the image data and the position data received at a first time; and
updating the position of the unmanned aerial system based on at least one of the image data and the position data received at a second time.

9. The method of claim 1, wherein determining a position of the unmanned aerial system based on at least one of the image data and the position data comprises: detecting a first unmanned aerial system based on a first image; detecting a second unmanned aerial system based on a second image; and determining that the first unmanned aerial system is the same unmanned aerial system as the second unmanned aerial system.

10. The method of claim 1, further comprising: detecting a plurality of unmanned aerial systems based on the image data using a trained machine learning model; and determining a position of each of the detected unmanned aerial systems based on at least one of the image data and the position data.

11. The method of claim 1, further comprising: retraining the machine learning model based on the detected unmanned aerial system and the image data.

12. The method of claim 1, further comprising: transmitting the alert to at least one of a user device comprising the imaging device, a command system, and at least one user device located within a threshold distance from the position of the unmanned aerial system.

13. The method of claim 12, wherein the threshold distance is a user-configurable threshold.

14. The method of claim 1, further comprising: generating a report comprising at least one of a location of the imaging device, a distance between the imaging device and the unmanned aerial system, an identifier associated with the imaging device, one or more images of the unmanned aerial system, and one or more confidence scores associated with the detection of the unmanned aerial system.

15. The method of claim 14, further comprising: receiving a first request from a user device; and in response to receiving the request causing the user device to display the report.

16. The method of claim 15, further comprising: receiving information from the user device associated with a user selection of an unmanned aerial system type from a plurality of unmanned aerial system types; and in response to receiving the additional information from the user device, updating the report with the unmanned aerial system type.

17. The method of claim 16, wherein the at least one imaging device comprises the user device.

18. The method of claim 1, further comprising: receiving a second request from a user device; and in response to receiving the second request, causing the user device to display a map, wherein the map depicts a geographic area associated with the position of the one or more detected unmanned aerial systems.

19. The method of claim 18, wherein the map comprises an icon depicting the location of the imaging device.

20. The method of claim 18, wherein the map comprises a user selectable icon indicating a position of the one or more unmanned aerial systems.

21. The method of claim 18, further comprising: receiving a third request from the user device associated with the user selectable icon, and in response to receiving the third request, causing the user device to display any one or more of: an image of the one or more unmanned aerial systems, a location of the one or more unmanned aerial systems relative to the imaging device, and temporal information associated with when the one or more unmanned aerial systems were detected.

22. The method of claim 1, wherein the imaging device is a mobile device.

23. The method of claim 1, wherein the imaging device is a surveillance camera.

24. A computing system for generating one or more alerts based on the detection of one or more unmanned aerial systems in image data, the system comprising one or more processors, memory, and one or more programs stored in the memory for execution by the one or more processors, the one or more programs including instructions that when executed by the one or more processors cause the system to:
receive image data and position data from at least one imaging device;
detect an unmanned aerial system based on the image data using a trained machine learning model;
determine a position of the unmanned aerial system based on at least one of the image data and the position data; and
generate an alert indicating detection of the unmanned aerial system.

25. A non-transitory computer-readable medium storing instructions for generating one or more alerts based on the detection of one or more unmanned aerial systems in image data wherein the instructions are executable by a system comprising one or more processors to cause the system to:
receive image data and position data from at least one imaging device;
detect an unmanned aerial system based on the image data using a trained machine learning model;
determine a position of the unmanned aerial system based on at least one of the image data and the position data; and
generate an alert indicating detection of the unmanned aerial system.
